(19) United States
(12) Patent Application Publication
(10) Pub. No.: US 2013/0254233 A1
(43) Pub. Date: Sep. 26, 2013

(54) SYSTEM AND METHOD FOR CONTEXT-SENSITIVE ADDRESS BOOK

(71) Applicants: Luciano Godoy Fagundes, Sao Paulo (BR); Thomas J. Moran, Galway City (IE); Dhaval Desai, Gujarat (IN); Joylee E. Kohler, Northglenn, CO (US)

(72) Inventors: Luciano Godoy Fagundes, Sao Paulo (BR); Thomas J. Moran, Galway City (IE); Dhaval Desai, Gujarat (IN); Joylee E. Kohler, Northglenn, CO (US)

(73) Assignee: Avaya Inc., Basking Ridge, NJ (US)

(21) Appl. No.: 13/424,407

(22) Filed: Mar. 20, 2012

(51) Int. Cl. G06F 17/30

(52) U.S. Cl. 707/776; 707/E17.014

(57) ABSTRACT

System and method to provide a self-organizing, context aware address book, the method including: receiving sensor data about a status of a user; receiving external data about a status of predetermined contacts of the user; data mining the external data based upon the sensor data and entries within the address book; calculating a respective likelihood value to at least a portion of the entries within the address book; determining a prominence for the portion of entries within the address book; and displaying the portion of entries within the address book with the prominence.

### BACKGROUND

1. Field of the Invention

Embodiments of the present invention generally relate to a context-sensitive address database, and, in particular, to a system and method for a context-aware address book that produces self-organizing listings based upon sensor data and external data gathered from social networking sites.

2. Description of Related Art

Known systems and methods for electronic databases such as an address book include a capability to produce a listing based upon one or more criteria, but these listings are generally limited in what can be searched for and how the results are displayed. Additional user effort may be needed in order to find the most relevant information based upon user-supplied contextual information, leading to inefficiencies and increased costs. The customer's perception may negatively affect their satisfaction with the electronic database.

Contacts are ordinarily pieces of information about people, places, businesses, etc. that a person wants to record for later reference at some point in the future. Many of the known tools to record or keep track of contacts are not sufficiently personalized. Some tools may include forms of crowd-sourcing (e.g., user star ratings), however, they are too generic and they do not adequately consider an end-user context in their results.

Therefore, a need exists to provide a context-sensitive database, such as an address book, in order to provide more timely and relevant search results to a user with less effort, and ultimately improved customer satisfaction.

### SUMMARY

Embodiments of the present invention generally relate to a context-sensitive address database, and, in particular, to a system and method for a context-aware address book that produces self-organizing listings based upon sensor data and external data gathered from social networking sites, and making inferences about a likelihood of user interest in contacts in the address book.

In one embodiment, a method to provide a self-organizing, context aware address book includes: receiving sensor data about a status of a user; receiving external data about a status of predetermined contacts of the user; data mining the external data based upon the sensor data and entries within the address book; calculating a respective likelihood value to at least a portion of the entries within the address book; determining a prominence for the portion of entries within the address book; and displaying the portion of entries within the address book with the prominence.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 illustrates at a high level of abstraction a mobile device to provide a context-aware address book, in accordance with an embodiment of the present invention; and

FIG. 2 illustrates at a high level of abstraction a method performed by the mobile device or modules thereof to provide a self-organizing, context-aware address book, in accordance with an embodiment of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “transmitter” may generally comprise any device, circuit, or apparatus capable of at least transmitting an information-bearing signal. The term “receiver” may generally comprise any device, circuit, or apparatus capable of at least receiving an information-bearing signal. The term “transceiver” may generally comprise any device, circuit, or apparatus capable of at least transmitting and receiving an information-bearing signal.

Embodiments of the present invention provide a system and method for provide a context-aware database, such as an address book to store contacts, in a way that is self-aware based upon data such as sensor data and external data, allowing a prominence to be calculated or inferred for substantially each entry in the database, and allowing for the database entry to be displayed in accordance with its calculated prominence.

A user's context may affect a person's interactions with the world around him, for instance interactions with other people, or interactions with businesses he may be seeking, or interactions with businesses vying for his spending, etc. Examples of ways in which interactions with businesses or persons may affected include a change in preference or willingness (either more or less) to patronize a business, or a change in the kind of patronage (e.g., buying additional goods or different kinds of services), or rearranging a schedule in order to meet with a person who is nearby and available, etc.

Contextual information may include a social context as determined by information gathered from or links to social or business networking sites such as Facebook, Twitter, LinkedIn, Yelp, foursquare, and so forth. Contextual information from networking sites may include: whether a person is connected to the user and/or other predetermined users; status (e.g., employment, relationship, etc.); membership in an affinity group (e.g., an alumni society, an interest group, etc.); likes and/or dislikes pertaining to persons, products, or services; activity levels; etc.

Contextual information may also include geographic or spatial information, or information received from short-range transmitters. For example, GPS data may be used to determine the location of the host mobile computing device (and ordinarily the user as well), and thus provide information that is customized for the user's location. For example, location can be used to provide a list or map of restaurants within a predetermined radius or travel time of the user's present location. The predetermined distance may vary based on, for example, a user's tolerance related to travel for the good or service being presented. A shorter predetermined distance may apply to goods and service providers who are plentiful and fungible, for example gas stations, fast food restaurants, and so forth. A longer predetermined distance may apply to less common types of providers (e.g., home improvement superstores, etc.) or providers of uncommon goods, services, or quality (e.g., five-star restaurants, houses for sale, etc.).

Embodiments in accordance with the present invention provide a system and method to provide a self-organizing, context-aware database. An example of a database may be an address book that stores contacts. A contact may include identification information about a person or business (e.g., name, address, phone number(s)), links to social or business networking sites (e.g., Facebook, Twitter, LinkedIn, Yelp, foursquare), a notes field, and so forth. The database may be coupled to a user interface implemented as an application program (i.e., “app”). The app and database together provide an address book in a mobile computing device, such as a smart phone, laptop PC, tablet PC, etc., in order to provide context-aware information to a mobile user.

Embodiments in accordance with the present invention may use data sources such as social networks and geo-location data (e.g., GPS data) in order to provide contextual information to the application. This context is used to prioritize the display to a user of selected entries of a database. Embodiments in accordance with the present invention provide a user interface that makes it easier for a user to find one or more database entries, such as a contact inside the address book, based upon the user's context.

Embodiments in accordance with the present invention provide prominence to selected entries, the entries being selected on the basis of the user's contextual information. For example, prominence may be by way of organization, such as being placed on a special list, or by being sorted within a list based upon a prominence value. For instance, the special list may be at the top of a display area, and the special list may include contacts that are located closer/closest to the user's position, or companies that have been mentioned in the user's twitter feed, etc. Embodiments in accordance with the present invention may analyze the user's context and may prioritize or otherwise give prominence to results based on the user's most immediate needs.

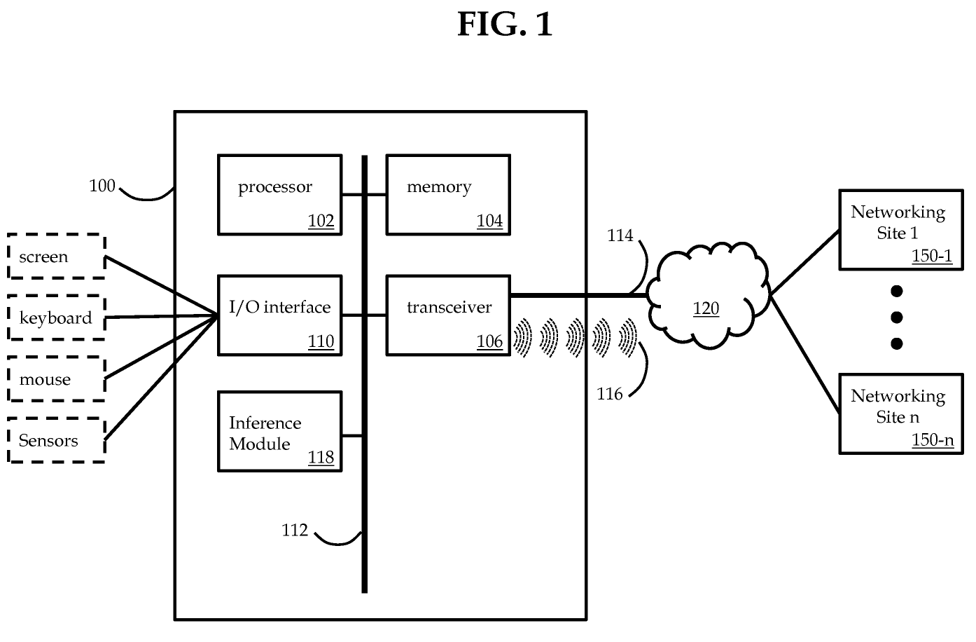

FIG. 1 illustrates at a high level of abstraction a mobile device 100 to provide a context-aware address book, in accordance with an embodiment of the invention. Mobile device 100 may include a processor 102, a memory 104 coupled to processor 102, a receiver, transmitter, transceiver 106, and/or I/O interfaces 110. Transceiver 106 couples mobile device 100 to an internal and/or external communication path such as an Ethernet connection 114 or an optional RF connection 116. RF connection 116 may be WiFi, Bluetooth, ZigBee, UWB, or similar technologies used for RF networking. I/O interfaces 110 couple mobile device 100 to one or more optional user input/output (I/O) devices (e.g., display screen, keyboard, mouse, etc.). Memory 104 stores data and/or program instructions used by processor 102. Memory 104 may include permanent, non-volatile memory (e.g., ROM), or volatile memory (e.g., RAM), or rewritable memory (e.g., hard drive or flash memory), or any combination thereof. For instance, memory 104 may include an address book database. Components of mobile device 100 may be interconnected by communication path 112. The program instructions, when executed by processor 102, carry out the processes performed by mobile device 100.

Mobile device 100 may communicate via Ethernet connection 114 and/or RF connection 116 to a wide area network 120 (“WAN”) such as the Internet, which in turn connects with one or more external networking sites 150-a through 150-n, wherein “n” is a positive integer. Mobile device 100 may connect with one or more of networking sites 150-a through 150-n on an intermittent basis (e.g., when a user logs in, or a polling basis) or on a substantially continuous basis (e.g., networking sites 150-a through 150-n push updates to mobile device 100).

It should be noted that embodiments of the present invention do not require any particular type of information transport medium between mobile device 100 and networking sites 150-a through 150-n, i.e., embodiments of the present invention may be implemented with any desired type of transport medium as well as combinations of different types of transport media.

Mobile device 100 further includes an inference module. The inference module may accept contextual information gathered from one or more networking sites 150-1 through 150-n, and/or one or more optional sensors. Based upon the contextual information, the inference module may then infer a respective likelihood that the user may be interested in a particular database entry.

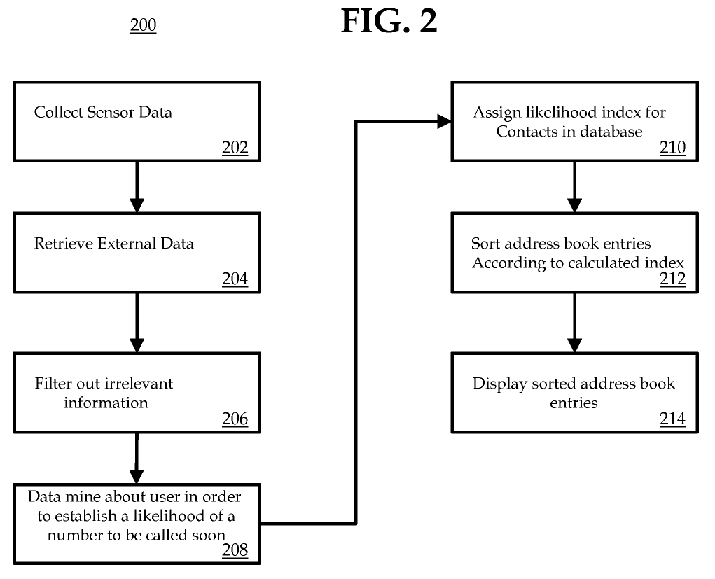

FIG. 2 illustrates at a high level of abstraction a method 200 performed by mobile device 100 or modules thereof (generically, “mobile device 100”) to provide a self-organizing, context-aware database such as an address book, in accordance with an embodiment of the invention.

A self-organizing feature refers to a capability that contextual information gathered as described herein will be analyzed and applied to database entries in order to calculate a respective likelihood value for substantially each of the database entries according to one or more criteria. The self-organizing feature may attempt to make inferences about what the user might be interested in or looking for, and use the inferences to calculate the likelihood value. For example, the inference may operate by observing or otherwise noting from a social network information such as a status (e.g., birthday, etc.), an activity (e.g., a mention of attending a sporting event, going on a vacation, etc.), a need (e.g., looking for a type of clothing), and so forth. The categories of information can be very broad, so the inference module may emphasize making inferences related to contacts that are in the user's address book. For example, if the user has numerous restaurants in their address book, the inference module may emphasize data mining the user's social network for references related to food or dining needs. In another example, if the user has numerous travel-related contacts (e.g., airlines, hotels, rental cars, etc.), the inference module may emphasize looking for travel-related information in the user's social network.

The inference module may also operate by identifying a need similar to categories of contacts in the user's address book, and then expand the contacts with a suggestion. For example, if a user has several restaurant-related contacts in their address book, the inference module may be monitoring the user's social network for dining-related references. Suppose then that a person in the user's social network mentions that they want to eat a certain kind of ethnic cuisine that is not in the user's address book (e.g., Italian, Thai, Mexican, etc.). The inference module may expand the user's address book by searching for and suggesting additional restaurants of the desired cuisine within a geographic region (e.g., region of the user or the person being followed).

Data mining will be used to identify the user's needs (for instance, searching for nearby restaurants serving a preferred menu). Suggestions may come from several different sources. A simple Google search may present several restaurant options. A more context sensitive search could be on its way by using Yelp or other social network sites that consolidate restaurant suggestions. A proximity-based search would assume that the user is using their address book on a smartphone that is GPS-enabled and can provide to the user the user's current location. A simple proximity-based search based search on Yelp would be adequate to provide good results for this scenario.

Inferences, in the form of likelihood values, may be calculated by correlating data mined from the social network with contacts in the user's address book, or attributes of those contacts. For example, attributes of a restaurant may include type of cuisine, location, price range, popularity, etc. If a person in the user's social network has a desire to dine at a particular type of restaurant. a higher likelihood value may be assigned when more attributes of contacts in the user's address book match the person's desired dining.

Prominences that depend upon the likelihood values of their respective database entries will then be determined, and the database entries will be displayed to a user based upon their respective prominences. The prominences may include organizing together (e.g., grouping) database entries having same or similar likelihood values. For example, based upon an inference that a user may be interested in a particular kind of good or service, database entries having a high likelihood value may be presented in a list sorted according to likelihood value. Alternatively, database entries having a range of likelihood values may be grouped according to a secondary criterion such as location, e.g., those providers of goods or services that are closest to the user's present location. Alternatively, information may be presented grouped according to a secondary criterion such as reviews from other persons such as friends, peers, or anonymous strangers. Reviews can be in the form of a rating like number of stars, thumbs up/down, a written review, contextual analysis of a written review, and so forth. Alternatively, information may be presented grouped according to multiple criteria, for instance first according to zones of distance (e.g., less than one mile, one to five miles, etc), and then by number of stars within each zone. Alternatively, an inference engine may already include secondary criterion when calculating respective likelihood values.

The self-organizing, context-aware feature can be applied to an end-user's contact list, similar to when the feature is applied to a listing, such as a yellow-pages book with company entries. Embodiments in accordance with the present invention are able to provide a self-organizing, context-aware address book with as much contextual sources as possible.

Referring again to FIG. 2, mobile device 100 at step 202 may collect and/or read sensor data such as date and time of day information, or a user calendar in order to provide current and future appointments. The data may also be gathered from other apps on mobile device 100, such as an email app or a calendar app.

The contextual sources of sensor data may also include GPS coordinate data. With GPS location information, embodiments in accordance with the present invention may determine the user's currently location, and prioritize local searches that are more likely to be needed at any given moment. Sensor data may also include information about the user's network connection, e.g., an Ethernet address, or a network identification or configuration.

Step 202 may also include receiving information via short range wireless (e.g., radio) transmissions. A receiver for a short-range transmission may be used to provide additional context information. For example, a person traveling near a store or near an advertisement for the store (e.g., a sign or billboard) may receive information from the store via a short-range transmitter about goods or services being offered, sales or other promotions, etc.

At step 204, mobile device 100 may retrieve and/or read external contextual sources, such as status updates from social networking sites. The external contextual sources may include Facebook™, which provides a social chart that allows the app in the user's mobile device to infer an end-user's preferences (e.g., the end-user's likes and dislikes). The app may be able to monitor status from the end-user itself and friends, in order to put into context a moment (either the present moment or a past moment) of the user's life, e.g., what the user is doing and why they are doing it.

Embodiments in accordance with the present invention use a user's history of online status and activities to create a profile of the user regarding the user's likes or dislikes. Embodiments in accordance with the present invention use the current state of the user to infer what the user is doing or wants to do in the near future. Embodiments in accordance with the present invention rearrange the smart address book in order to bring up the items that the user likely will need the most, based on history, in order to accomplish what the user wants to accomplish based on their present status and/or status in the near future. An end-user's life may be viewed as a sequence of events and status changes that have been digitally registered on the user's accounts at social networks sites such as Facebook.

For example, Facebook status can be modified by third party apps, such as foursquare. Foursquare is a web and mobile application that allows registered users to post their location at a venue (i.e., “check-in”) and connect with friends. Check-in requires active user selection and points are awarded at check-in. Users can choose to have their check-ins posted on their accounts on Twitter, Facebook, or both. Foursquare enables push-notification of friend updates (i.e., “pings”). Embodiments in accordance with the present invention may monitor accounts on social networking sites for status modifications made by such third-party apps like Foursquare. For example, in response to a foursquare check-in at a local amusement park, embodiments in accordance with the present invention may rearrange itself in order make the park contact readily available at the top of the list.

In another example, if a user sets their Facebook status to “looking for a gift for my Mom”, embodiments in accordance with the present invention, upon monitoring Facebook and noticing the change, may bring up store contacts that sell merchandise or services that the user's mother may like.

At step 206, mobile device 100 may filter out irrelevant information from the information collected in step 202 or retrieved in step 204. Irrelevant information may include information that would not affect a ranking or prominence assigned to a display of database entries. Irrelevant information may include smiley faces, gibberish, non sequiturs, acronyms like “LOL”, and so forth. Filtering of irrelevant information is the discarding of data known or highly suspected to be useless or irrelevant, whereas data mining may include the selection or retention of data known or highly suspected to be useful or relevant, in addition to the filtering of irrelevant information.

At step 208, mobile device 100 may use data mining techniques as known in the art in order to calculate a likelihood value to substantially each contact in the address book. Step 208 may use as inputs the sensor data gathered in step 202 and the external data gathered in step 204, then for substantially each contact in the address book calculate a likelihood value that the user will want to call or otherwise contact the listing at this time or in the near future. A weight may be assigned for each data source, and the weighting may vary for different types of information. For example, a user may have accounts on both a travel-related site and a book-related site (e.g., Amazon) and may post information on both sites about travel and books. Information from the travel-related site may be given more weight if it pertains to travel, but information on the book-related site may be given more weight if it pertains to books.

Embodiments in accordance with the present invention may use external data to sort the user's contact list based on most likely needs of the user. For example, “end-user is on a trip in a different state” could mean that local friends and family get priority on the list; “end-user is on a business trip” could mean that closer customers and company offices get higher priority on the list.

At step 210, mobile device 100 may assign a likelihood value for substantially each contact in the address book. Although step 208 uses a formula to define a weight for each item of the list, step 210 commits (i.e., accepts) that information and assign that weight to the actual record.

At step 212, mobile device 100 may sort the address book contacts according to the likelihood value calculated from step 210.

At step 214, mobile device 100 may display at least a selected portion of the address book contacts, and in particular those address book contacts having the greatest likelihood value. The selected portion may include a sorted listing, or a listing for which the entries having the greatest likelihood value are otherwise prominently displayed.

A user may or may not be able to drill down and see the reason why certain entries were prominently displayed. In circumstances with rule-based computing, the rules could be used to define a likelihood formula and those rules could be verified by the user. However, for more abstract-based computing (e.g., neural network computing process), there are no readable rules what would provide for a user to drill down to understand the reason for a particular ranking.

Whether the steps of method 200 may be grafted into an existing address book, or whether the address book has to be maintained as a self-contained and contact managers depends on the commercially available address books and their integration methods. For example, on iOS, apps may read from an address book so an embodiment in accordance with the present invention would just need to keep a table with two fields, the index and a pointer to its contact. This could be integrated with other third-party contact managers that provide APIs to read and update their data.

Contextual sources of information used in method 200, in particular at least at step 204, may be used as a basis to create a self-organizing listing or a display (e.g., grouped according to a calculated prominence, or a tabbed interface, etc.) on a user's mobile device. The self-organizing listing or display may be located inside the end-user contact list, and its display may be filtered and sorted based on one or more of the user's contextual sources of information. For example, it may be desirable that a user should be able to find what he/she is looking for within the top five results of the list, once the contextual contexts are taken into account.

The contextual sources may include Twitter™, which provides a substantially real-time data feed containing news and commentary from a sender. A user may choose to follow (i.e., to subscribe to) the data feed from a particular sender. A user's choice of what Twitter senders to follow represents the user's interests. Since the Twitter feed is a public communication channel, the app may be able to mine the Twitter data feed in order to find data, status, complaints, positive or negative comments about a product or business, etc. regarding the sender and/or receiver. For example, if a user is following a celebrity's Twitter feed and the celebrity mentions a brand of merchandise, the user may be interested in knowing what nearby stores sell that brand of merchandise. A user's outgoing Twitter feed may also be data mined for additional contextual information.

By incorporating information from more than one data feed (i.e., more than one networking source), embodiments in accordance with the present invention provide a more robust capability than what can be achieved through simple contextual advertising. For example: a user may see on a twitter feed that a friend is coming to the user's town from very far away; from Facebook, the user may know that the birthday of the user's friend's is soon; and from Linked-In the user may see that the user's friend is in town for a business trip. In this situation, embodiments in accordance with the present invention may suggest to the user a restaurant that is close to the office of the user's friend office for lunch to celebrate the friend's birthday.

The contextual sources may include Facebook™, which provides social updates from Facebook members. A user may become a friend of a Facebook member, thereby allowing the user to send and receive social updates and messages from the Facebook member, receive notices about activities by the Facebook member (e.g., joining a group, etc.), receiving reminders (e.g., the Facebook member's birthday), or other information about the Facebook member (e.g., liking a particular musical group, newspaper article, etc.). A user's choice of Facebook members to become friends with, and the social information provided by the Facebook member, is information that the app may be able to mine in order to find data, status, complaints, positive or negative comments about a product or business, etc. regarding the sender and/or receiver. For example, if the Facebook member “likes” a particular brand of merchandise, and Facebook indicates that it is close to the Facebook member's birthday, the user may be interested in knowing what nearby stores sell that brand of merchandise.

The contextual sources may include LinkedIn™, which provides business-oriented updates from LinkedIn members. A user may become connected to a LinkedIn member, thereby allowing the user to send and receive business-oriented updates and messages from the LinkedIn member (e.g., connections with new members, joining a group or mailing list, etc.). A user's LinkedIn network, and the business-oriented information provided by the LinkedIn member, is information that the app may be able to mine in order to find data, etc. regarding the sender and/or receiver. For example, if the LinkedIn member has posted information about a job opening at a company, the user may be interested in knowing more about the company from news sites.

Further examples of usage of contextual sources of information may include the following:

(a) Suppose that a user is preparing for a vacation trip and the user tweets that information. A system and method in accordance with an embodiment of the present invention may be able to self-organize relevant information and display information related to tourism that the user has in their contact list at the top of the list.

(b) Suppose that a user also has pressed a “Like” button for some main attraction like an amusement park on Facebook just after the tweet described above in (a). A system and method in accordance with an embodiment of the present invention may search the web and bring information related to hotels and resorts associated with the main attraction to the top of the list, together with information about any featured hotels, special deals, and so forth, near to or in connection with the main attraction.

(c) Contextual information in the form of GPS coordinates may be used to deduce the user's location (e.g., near the main attraction), and thus provide information about related attractions like hotels and ticket offices around the main attraction, in order to assign a higher priority to those related attractions so that they show up more prominently on the list. Prominence is ordinarily by way of the display order (i.e., the first listed item is the most prominent), but prominence may also be provided by placing the prominent listing in a predetermined location (e.g., on the side), or displaying the prominent listing with a different font (e.g., bigger, bolder, italicized, different color, underlined, blinking, etc.), or displaying the prominent listing next to a marker (e.g., arrow, dot, thumbs-up, stars, etc.).

(d) The GPS coordinates contextual information may show that the user has entered the attraction or is otherwise near enough to be interacting with the attraction. The context-aware address book in accordance with an embodiment of the present invention may then automatically organize itself to bring emergency telephone numbers and other amenities such as restaurants, gift shops, etc. that the user may want or need while at the attraction.

(e) Suppose that a user has a relationship on Facebook with a business entity such as a local power company. The power company may send a message informing their customers and other interested parties that there will be a planned power outage for a period of time. The context-aware address book in accordance with an embodiment of the present invention can raise the priority of the local power company contact for that period of time and give it prominence (e.g., the top of the list, etc.) so that the customer can get more information in case he/she needs to.

(f) Suppose that the user is a company manager who is visiting a company branch. The context-aware address book in accordance with an embodiment of the present invention may be aware of the location and also be aware of friends of the manager based on a social graph. The context-aware address book may self-organize itself to bring all the most important extension numbers to the top of the list as it is more likely that the manager will want to talk to a local person during that particular moment in time.

(g) Suppose that the user is a person who, when they are on a business trip, will always call home at a particular time of the day and may even enter a ‘call home’ reminder in their calendar. The context-aware address book in accordance with an embodiment of the present invention would recognize or infer a regularity of the user's schedule, and may raise the priority of the “home” contact for that particular time of the day.

The contextual sources discussed above are illustrative examples. Embodiments in accordance with the present invention may use other contextual sources of information.

Embodiments in accordance with the present invention provide a detailed level of personalization that can be applied to an end-user contact list. Embodiments in accordance with the present invention may have as a goal that the best result in a qualitative and/or quantitative sense should be among the top 10 most prominently-listed contacts.

Embodiments of the present invention include a system having one or more processing units coupled to one or more memories. The one or more memories may be configured to store software that, when executed by the one or more processing unit, allows implementation of a context-aware address book, at least by use of processes described herein by FIG. 1 and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

1. A method to provide a self-organizing, context aware address book, comprising:
receiving external data about a status of a predetermined contact of the user, wherein the received external data comprising social contextual information from a plurality of social networking sites;
data mining the external data based upon the sensor data and contacts in the address book;
calculating a respective likelihood value of at least a portion of the contacts in the address book based upon the data mined related to the social contextual information gathered from the plurality of social networking sites;
determining a prominence for the portion of contacts of the address book; and
displaying the portion of entries of the address book with the prominence.

2. The method of claim 1, further comprising:
receiving sensor data about a status of a user; and
calculating a respective likelihood value of at least a portion of the contacts of the address book based upon the sensor data.

3. The method of claim 1, wherein the sensor data comprises GPS data.

4. The method of claim 1, further comprising:
receiving information via short range wireless transmissions; and
calculating a respective likelihood value of at least a portion of the contacts of the address book based upon the information received via the short range wireless transmissions.

5. The method of claim 1, wherein the prominence comprises a sorted order of display.

6. The method of claim 1, wherein the external data comprises data gathered from a social or business networking site.

7. The method of claim 1, wherein data mining comprising analyzing textual external data gathered from a social or business networking site.

8. The method of claim 1, wherein calculating a respective likelihood value comprises correlating the data mined with attributes of contacts of the address book.

9. The method of claim 1, wherein the data mining is based upon contents of the address book.

10. A system to provide a self-organizing, context aware address book, comprising:
a data interface configured to receive external data about a status of a predetermined contact of the user, wherein the received external data comprising social contextual information from a plurality of social networking sites;
a data mining module configured to data mining the external data based upon the sensor data and contacts in the address book;
a calculation module configured to calculate a respective likelihood value of at least a portion of the contacts in the address book based upon the data mined related to the social contextual information gathered from the plurality of social networking sites;
a processor configured to determine a prominence for the portion of contacts of the address book; and
a display configured to display the portion of entries of the address book with the prominence.

11. The system of claim 10, further comprising:
a data interface configured to receive sensor data about a status of a user; and
a calculation module configured to calculate a respective likelihood value of at least a portion of the contacts of the address book based upon the sensor data.

12. The system of claim 10, wherein the sensor data comprises GPS data.

13. The system of claim 10, further comprising:
a data interface configured to receive information via short range wireless transmissions; and
a calculation module configured to calculate a respective likelihood value of at least a portion of the contacts of the address book based upon the information received via the short range wireless transmissions.

14. The system of claim 10, wherein the prominence comprises a sorted order of display.

15. The system of claim 10, wherein the external data comprises data gathered from a social or business networking site.

16. The system of claim 10, wherein the data mining module comprises a module configured to analyze textual external data gathered from a social or business networking site.

17. The system of claim 10, wherein the calculation module comprises a module configured to correlate the data mined with attributes of contacts of the address book.

18. The system of claim 10, wherein the data mining module is configured to data mine based upon contents of the address book.

19. The method of claim 1, wherein the plurality of social networking sites comprising Facebook, Twitter, LinkedIn, Yelp, and foursquare.

20. The method of claim 1, wherein the social contextual information comprises a status, an activity, membership in an affinity group, likes, a preference, and a need of a user.
